(19) United States
(12) Patent Application Publication
(10) Pub. No.: US 2004/0157030 A1
(43) Pub. Date: Aug. 12, 2004

(54) Self adhesive label feedstock and method

(76) Inventor: John Frankhuisen, Craigmore (AU)

Correspondence Address: MCNEES, WALLACE & NURICK, 100 PINE STREET, P.O. BOX 1166, HARRISBURG, PA, 17108-1166, US

(21) Appl. No.: 10/477,793

(22) PCT Filed: May 14, 2001
(86) PCT No.: PCT/AU01/00551

(51) Int. Cl. B32B 9/00

(52) U.S. Cl. 428/42.3

(57) ABSTRACT

A self-adhesive label feedstock (1) for use with machine applicators in a non-stop beverage container labelling operation is disclosed and method of use. The feedstock (1) has a plurality of machine releasable self-adhesive beverage container labels (3,5) releasibly adhered to a concertina folded backing web (7). In non-stop beverage container labelling operation the backing web (1) of one feedstock is joined to the backing web of another feedstock.

### FIELD OF INVENTION

The invention pertains to a method and means involving self-adhesive labelling using feedstock in labelling beverage containers particularly wine bottles.

### BACKGROUND OF THE INVENTION

There are a number of different types of label feedstock and labelling methods for use with machine applicators in labelling bottles.

High-speed beverage container labelling lines such as those typically used in larger breweries or soft drink manufacturers commonly machine apply labels by a wet glue method. where an applicator machine applies wet glue to the back of paper labels and then apply the labels to the bottles.

A bottle labelling line using wet glue may operate at 450 bottles a minute. A beer bottle labelling line using wet glue can achieve speeds of 900 bottles a minute. The difference between the two is that labels need to be well positioned on wine bottles whilst it is acceptable to have a greater number of miss-positioned and wrinkled labels on beer bottles. These lines run continuously with hoppers of feedstock labels and glue.

However, the use of the wet glue method has the disadvantage of poor presentation which is to say that the labels may suffer from wrinkling and finger marks. There are also limitations in relation to the printing techniques that may be used on the labels.

An alternative to wet glued labels is use of self adhesive techniques where the labels are self-adhesive labels. Self-adhesive labels have a number of advantages over wet glued labels particularly in their presentation. The applied labels do not normally suffer from wrinkling or finger marks. It is also possible to use a broader range of printing techniques, as it is possible to combine more techniques in one machine.

A main disadvantage of using self-adhesive labels is that a labelling line using self adhesive labels needs to have a backing web of paper which can be supplied only in finite lengths. Such finite lengths are supplied in rolls and each roll with current techniques is run through so that at the end of each run the bottling line must be stopped and a new roll re established. For this reason self adhesive lines will conventionally be run at a significantly lower effective speed when compared to the wet glue method. The self-adhesive label feedstock for use with machine applicators as was stated is currently provided as a ‘continuous’ roll of a finite length as compared to the availability of a hopper supply of labels which can be replenished “on the run” when wet glue is used. The labelling line must therefore be stopped when a roll runs out to remove a used roll former and fit and set up another roll in the machine. As a direct result of this a fast self-adhesive label bottle labelling line will at best achieve effective over a given period speeds of 360 bottles per minute. This is a significant reduction in time and represents a substantial extra cost compared with wet glue rates.

Another disadvantage with the use of self-adhesive labels is the need for high quality control over the manufactured labels and particularly the backing webs. Self-adhesive labels are die cut from self-adhesive roll stock that has face stock which is to say the sheet from which labels are cut are releasably adhered to the backing web.

If a die which is used to cut the label “over cuts” which is to say it cuts deeper than just the face stock and nicks or gashes the backing web, most line engineers will reject the whole roll because this can result in a break in the line and resultant serious down time to re-establish and reset the line. In other words such nicks or gashes in the web are as a matter of course expected to so weaken the web that it will break when under conventional tension on the line and stop production for a significant time period.

It is currently possible to overcome the need to stop the line for each roll replacement but such current techniques as are currently known to the applicant require expensive equipment and it can be entirely uneconomic for a specific winery to invest in such required expensive equipment.

One of the existing methods of providing for non-stop operation for self adhesive rolls is to incorporate flying splice machines into the line. However as has been stated the cost for each splice machine and the number of machines that will be required for a line makes this a very expensive option indeed. and therefore for most, uneconomic.

### OBJECT OF THE INVENTION

An object of the present invention is to provide a an alternate answer to achieving continuous application of self-adhesive labels for bottling lines and especially for labelling of wine bottles which will allow for continuous operation which allows for a less expensive option than has been the case hitherto

### BRIEF SUMMARY OF THE INVENTION

In one form of this invention this can be said to reside in a self-adhesive label feedstock arrangement for use with machine applicators in a wine bottle labelling operation, the feedstock having a plurality of machine releasable self-adhesive labels releasibly adhered to a concertina folded backing web, and where there are perforations along each fold line to facilitate compact stacking of the web in the concertina, and there are at least two stacks of such concertina folded backing web, a first stack connected to a second stack by having a tail of the first stack connected to a top of the second stack.

In a further form of this invention there is proposed an assembly providing for potentially continuous feed of labels from self-adhesive label feedstock for use with machine applicators in a non-stop wine bottle labelling operation, the feedstock having a plurality of machine releasable self-adhesive labels releasibly adhered to a concertina folded backing web, and where there are perforations along each fold line, and there being at least two stacks of concertina folded backing web with attached labels, a first stack having a top connected to a label applying machine and having its tail connected to a second stack by having the tail connected to a top of the second stack.

In a further form of this invention this can be said to reside in a method of machine labelling of wine bottles with self-adhesive labels including the steps of providing for continuous feed of labels from self-adhesive label feedstock for use with machine applicators in a non-stop wine bottle labelling operation, the feedstock having a plurality of machine releasable self-adhesive labels releasibly adhered to a concertina folded backing web, and there being perforations along each fold line to enable compact folding, and there being at least two stacks of concertina folded backing web with attached labels, a first stack having a top connected to a label applying machine and having its tail connected to a second stack by having the tail connected to a top of the second stack, the steps of the method including drawing the web from the first stack and then continuing to draw the web from the second stack by pulling the top of the second stack by use of the tail of the first stack.

Another embodiment of the invention is the use of the above feedstock with a machine applicator to label beverage containers.

Another embodiment of the invention is a method of machine labelling of beverage containers with self-adhesive labels by using a plurality of units of label feedstock, each unit of feedstock having machine releasable self-adhesive beverage container labels adhered to a concertina folded backing web, wherein the backing web of a unit of feedstock is joined to the backing web of another unit of feedstock.

For a better understanding of this invention it will now be described with reference to a preferred embodiment which shall be described with the assistance of drawings hereinafter.

### BRIEF DESCRIPTION OF THE DRAWINGS

FIG. 1 is a perspective view of the feedstock of the present invention.

FIG. 2 is a top plan view of the feedstock of the present invention.

FIG. 3 is a perspective view of three units of feedstock of the present invention joined together.

### DETAILED DESCRIPTION OF THE INVENTION

The present invention is predicated on a discovery that it is possible to place self-adhesive label feedstock for use by machine beverage container label applicators into a configuration that avoids the need to stop the applicators and change rolls during a run which will also then allow such configuration to be sufficiently compact for efficient transport and also not weaken a backing web to an extent that will mean it may possibly tear under high tensions that apply in such a high speed line. This meant two things, a first being that in order to have an efficient compact stack in concertina arrangement, the fold line has to be scored.

This then allows for “continuous” feed (continuous in the context of this specification means as long as is required by the user) with significant savings in relation to the time that is otherwise taken in changeover from each consecutive roll of labels to roll of labels.

It has been found that if self-adhesive beverage container label feedstock has a concertina folded backing web it is possible to avoid the need to change rolls of feedstock on applicator machines. The backing web of one unit of feedstock can be attached to the backing web of another unit of feedstock and thereby extend the effective length of self-adhesive label feedstock (this being then effectively to an end of a run). Further units of feedstock will then be attached to end of the backing web of the chain of units of feedstock. The backing web is attached together from one concertina stack to another by using adhesive tape as one example. The units or stacks of feedstock are stored in individual cartons or boxes.

In order to achieve a concertina fold (also known as a fanfold or zigzag fold) a backing web of the feedstock is passed through a machine which perforates the backing web at equally spaced apart locations along the web which are then defining panels on which the labels are adhered and where the panels are then successively laid down with the perforated fold line providing a compact and accurately defined fold. This type of folding now facilitates ready access to the start and the end of a strip of backing web. When stored in cartons as a stack a start and end of a feedstock stack can then be both located at the top of the carton so that the end or bottom of a stack of the feedstock will pass from a bottom of the carton up the inside of a rear side of the carton and be positioned onto the rest of the feedstock on a side that is opposite to a run out side. This then allows for successive stacks to be attached top to bottom so that there can in theory be an infinite length of feedstock positioned with sequentially secured backing web which can be fed therefore in essentially a continuous manner to a bottling line.

The carton may in one embodiment have a passage (or be capable of having a passage formed by a tear away portion or other means) at a bottom of a rear side of the carton by which an end of a particular stack of the feedstock may be accessed for arranging the location of an end for access for a subsequent top of a subsequent stack

By way of contrast a continuous roll of feedstock only provides easy access to the start of the feedstock. A remainder of the feedstock in a roll envelopes the end of the backing web which is therefore implicitly not available.

The feedstock has self-adhesive labels releasibly affixed to a backing web. The adhesive used with the labels and the backing web is selected to permit the labels to be detached from the web by a machine applicator and affixed to a bottle. One means of releasibly affixing labels to a backing web is to use a backing web formed from silicone coated paper.

The backing web includes the step of using perforations to form fold lines. The problem addressed here is that a perforation will implicitly weaken the backing web. For a bottling line there will be considerable longitudinal tension which is applied to the web. To weaken this web can lead to the web tearing and this is an intolerable result. Accordingly the problem has been whether it has been sensible to even consider a process that will need perforation of the web where any perforation previously (the “overcut” a problem) has resulted in a mantra that the web is not to then be used in the bottling line. A longitudinal backing web may be machine folded into the concertina configuration by including regularly spaced transverse lines of perforations and by using a directing arm to control the packing of the feedstock.

It is a requirement that perforations (extending across a width of the web) are used to fold the web so that this can provide a crisp 180° fold in the backing web. This allows the stock to be tightly packed within a box or carton. It is simply not realistic in a commercial sense not to have a compact packing of the web. When the web is folded by a scoring means which is to say that the web is weakened but not penetrated the folds are not crisp, and will result in the web lying with raised ends that results in these being loose in a box or carton and this causes two problems. A first of these is that the cost of transport which can be space based and not weight based becomes much higher for a given number of labels and also an area for storage required is much more in both a printing facility and also in a bottling facility. Such problems in a commercial sense may remove a lot of any advantage of continuous runs. When the backing web is folded by using perforations, it has been a surprising discovery that an extent of perforations across can be found which reduces a folding standup to a sufficient extent to make the packing of a stack seriously compact while not unduly reducing the tear potential so that the web will reliably maintain tensile strength of the backing web sufficiently to ensure that it does not tear in a normal application of a high speed applicator line. The discovery then is that it is possible to find an effective compromise between a flat concertina and a sufficiently strong web for the demands of a bottling line high speed application. Actual sizes, shapes and positions of perforations in fold lines in backing web are selected according to the grade and thickness of the backing web and would be expected to be different for each application. However by having perforations that do not extend fully to each side of a web so that there is some has helped to achieve this compromise. Backing webs will have different tensile properties depending on their dimensions and materials from which they are made Some incidental experimentation will be useful for each case and show that there is a possible answer for this problem along the lines explained.

It is useful then to customise types of perforations used with the backing web in order control breakage of the feedstock on a particular type of applicator machine, or even with a specific machine as applicator machines can be operated at different tensions. Alternatively the type of backing web may be changed to provide a web having a greater tensile strength in the perforated sections. In some cases it is useful to adjust the settings of an applicator machine to reduce the stresses applied to the backing web during the process of labelling beverage containers. Some applicator machines include a tension control means for controlling the tension of the web.

The backing web of the feedstock may be folded as a separate treatment of self-adhesive label feedstock or as part of an overall process for making the feedstock. In the latter case the process may use commercially available self-adhesive roll stock, such as Kantac C51 and C58. This roll stock is typically used to manufacture rolls of self-adhesive label feedstock for use in labelling wine bottles. This will allow standard techniques for producing rolls of self-adhesive label feedstock to be combined with a process that produces a concertina folded backing sheet.

Commercially available self-adhesive roll stock used in making rolls of self-adhesive labels has a layer known as face stock releasibly adhered to a backing web. The adhesive used to adhere the face stock to the backing web may be permanent wine grade or semi-repositional. Permanent adhesive will bond a label to the glass of a bottle in a manner that will not permit its routine removal. A semi-repositional adhesive allows the label to be routinely removed from the bottle for within a time period. After that period the adhesive takes on a more permanent character. By way of example Kantac C58 uses a permanent wine grade adhesive and Kantac C51 uses a semi-repositional wine grade adhesive.

The roll stock may also be manufactured on site for subsequent processing. The manufacture of roll stock typically involves the selection of suitable paper backing and applying a silicone coating or other release agent to at least one side to form the backing web used in the stock. Wine grade adhesive is applied to the silicone coating and front stock is applied to the adhesive to form the roll stock.

The face stock can be treated to form machine releasable labels for use on beverage containers, specifically glass bottles. The treatment may involve simply printing on and cutting the face stock to provide labels. It may include applying affixing other layers to the face stock.

The process of producing self-adhesive beverage container label feedstock from the stock needs to include the step of concertina folding the backing web. This step may occur before treating the face stock to form labels, during the process of treating the face stock or once the labels have been formed. Preferably the folding step involves placing lines of perforations in the backing web at regular or uniform apart distances intervals so to facilitate the backing web to neatly and tightly lie onto of itself.

The treatment of the face stock to form labels may also involve printing indicia thereon, such as wine, spirit or beer brand information and other information about the contents of the container.

The treatment may also include cutting desired label shapes in the face stock to form labels and excess material and removing the excess material. The cutting may be done by any means known in the field including die cutting and laser cutting techniques.

The beverage container labels in the feedstock are preferably labels for use on the outer surface of a glass bottle. The labels are preferably regularly spaced on the feedstock for application by machine applicators.

The feedstock may include a number of different labels all for application to the same bottle. The feedstock may have two (or more) labels in a transverse section of the feedstock. On application to a bottle this will result in the bottle having separate top and bottom labels. Alternatively the feedstock may have different labels located near to each other along the feedstock for use as separate front and rear labels on a bottle.

The labels may have a regular or irregular shape and may have been subjected to a number of printing techniques.

In use applicator machines transfer the labels from the feedstock to beverage containers, such as wine, spirit or beer bottles. Standard applicator machines for use with rolls of self-adhesive labels, such as Krones applicator machines, may be used in the process. Typically the labels are removed from the backing web by having sharply changing the direction of movement of a line of feedstock over a beak. Whilst the backing web should sharply change direction around the beak, the labels are not pulled around and will therefore, peel away from the backing web for application to a bottle.

As the label leaves the backing web it is brought into contact with bottle. The bottle is typically spun near the beak of the applicator to achieve good attachment of the label. The bottle and label may then pass a roller to firmly affix the label to the bottle. The bottle may then move onto another beak to apply another label to the bottle.

A line may apply a number of different labels to a container depending on the arrangement of labels on a backing web. The feedstock may have two different and alternating labels on the backing web for application on the front and rear faces of a bottle. With such an arrangement the applicator machine will typically pause the line between labels to allow for the repositioning of the bottle. The applicator machine also will include one or more sensors that spot the die gap between labels in order to assist in the positioning of the labels on the bottle.

To assist in the understanding of the invention various non-limiting embodiments of the invention will now be described with reference to the accompanying drawings.

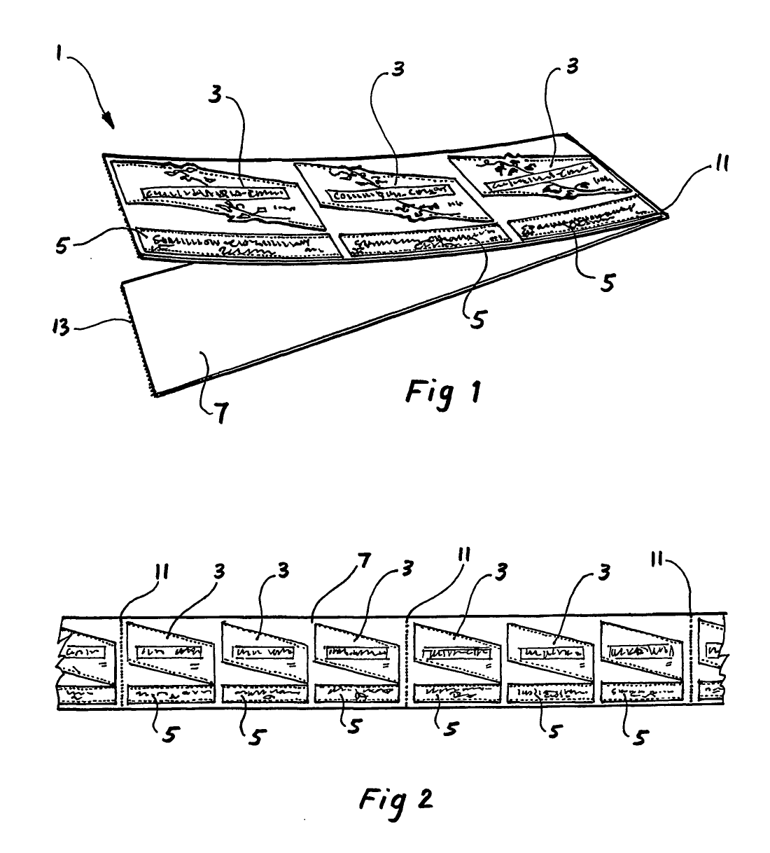

FIGS. 1 and 2 show a section of the feedstock (1) of the invention. The feedstock includes self-adhesive labels (3) and (5) releasibly affixed to backing web (7). The labels are regularly or uniformly spaced apart on the backing web for ease of application to wine bottles. This feedstock includes two different labels, an upper label (3) and a lower label (5). In use a machine applicators will apply the both labels to the same bottle and with the same relative position to each other.

The feedstock includes a number of regularly spaced fold lines (11) formed by perforating the web but not extending such perforations to a respective edge. An end of the backing web (13) is formed by tearing off an excess web at a fold line of the feedstock.

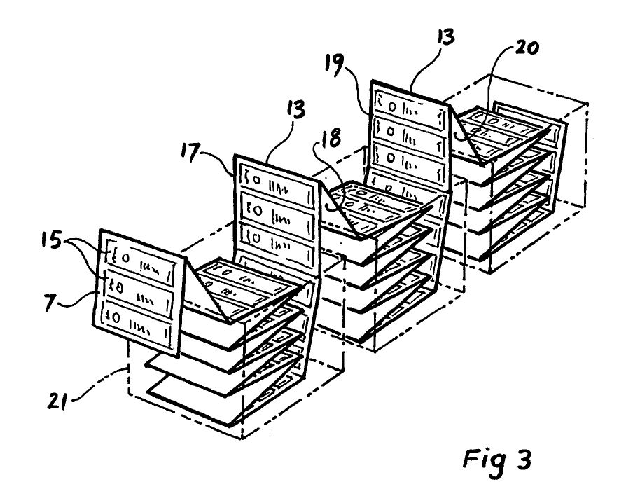

FIG. 3 show three units of feedstock having long labels (15) on backing web (7). The feedstock has been expanded to clearly show the concertina folding arrangement. In practice most of the sheets of a unit of feedstock will lie on top of each other in the concertina configuration and of course tightly packed because of the chosen extent of perforation.

The units of feedstock are located within separate cartons (21) drawn in outline. The last portion of the backing web of units of feedstock (17) and (19) is located near a rear of the mouth of the cartons. The portions (17) and (19) are joined along edge (13) to the starting portion of the next unit of feedstock (18) and (20) respectively to form a chain of feedstock.

The cartons are arranged in a line to minimise strain on the feedstock as the applicator machine draws from a new unit of feedstock. Additional feedstock can be added to the line by simply adding another carton and joining the new feedstock on to the end of the current feedstock. This has the result then that the feedstock can be supplied as a continuous length without the machine having to stop and reload a roll of labels as has been the previous case.

A further advantage of the invention is that a “stack” held within a carton can be used with either one end of the stack or the other end of the stack uppermost for feed to a labelling machine. This is useful where a labelling machine is different from that expected so that a left edge leading stack can be converted to a right edge leading stack simply by turning the stack upside down. The carton can be easily accessed in such a case (by for instance having facilitating score lines in the cardboard of the carton) and of course rewinding as might be the case previously with a roll is now no longer necessary. With either end uppermost, still the tail to top connection can be effected as previously described for stack to stack to provide a substantially continuous feed.

The above description is provided for the purposes of exemplification only and it will be understood by a person skilled in the art that modifications and variations may be made without departing from the invention.

Claims defining the invention are as follows:

1. A self-adhesive label feedstock arrangement for use with machine applicators in a non-stop bottle labelling operation, the feedstock having a plurality of machine releasable self-adhesive labels releasibly adhered to each of at least two stacks of a concertina folded backing web, and where there are perforations through the backing web extending along each fold line and being such as to facilitate compact stacking of the web in the concertina, and the at least two stacks of such concertina folded backing web are connected so that a first stack is connected to a second stack by having a tail of the first stack connected to a top of the second stack,

2. A self-adhesive label feedstock arrangement as in claim 1 further characterised in that the backing web is folded in each stack where a distance apart is equal of each fold line from a sequentially in line fold line. A self-adhesive label feedstock arrangement as claimed in claim 1 wherein the labels are wine bottle labels and the labels each display information regarding wine or other beverage.

3. A self-adhesive label feedstock arrangement as claimed in claim 1 wherein the backing web is silicone coated.

4. The use of the feedstock of any one of claims 1 to 3 with a machine applicator to label beverage containers.

5. Feedstock for use with machine applicators self adhesive labels in a non-stop bottle labelling operation, the feedstock being in the form of at least two concertina folded stacks having a plurality of machine releasable self-adhesive labels releasibly adhered to backing web in each stack and each stack having perforations through the backing web extending along each fold line and being such as to facilitate compact stacking of the backing web in the concertina, and each stack of such concertina folded backing web being adapted to be connected so that a first stack is connected to a second stack by having a tail of the first stack connected to a top of the second stack and provide thereby for feed of feedstock to the labelling operation without interruption from one stack to the next stack,

6. An assembly providing for potentially consecutive feed without interruption of labels from self-adhesive label feedstock in stacks for use with machine applicators in a substantially non-stop wine bottle labelling operation, the feedstock having a plurality of machine releasable self-adhesive labels releasibly adhered to a concertina folded backing web, and where there are perforations along each fold line, and there being at least two stacks of concertina folded backing web with attached labels, a first stack having a top connected to a label applying machine and having its tail connected to a second stack by having the tail connected to a top of the second stack such that as the first stack runs out the tail of the first stack will pull the top of the second stack which will then feed by unfolding from the top of the second stack.

7. A method of machine labelling of beverage containers with self-adhesive labels including the steps of providing for continuous feed of labels from self-adhesive label feedstock for use with machine applicators in a non-stop beverage container labelling operation, the feedstock having a plurality of machine releasable self-adhesive labels releasibly adhered to a concertina folded backing web, and there being perforations along each fold line to ensure compact folding, and there being at least two stacks of concertina folded backing web with attached labels, a first stack having a top connected to a label applying machine and having its tail connected to a second stack by having the tail connected to a top of the second stack, the steps of the method including drawing of the backing web from the top of the first stack and then continuing to draw the backing web from the second stack by pulling the top of the second stack by use of the tail of the first stack to which it is attached.

8. A method as in the immediately preceding claim further characterised in that the beverage containers are wine bottles.

9. A self-adhesive label feedstock for use with machine applicators in a non-stop beverage container labelling operation, the feedstock having a plurality of machine releasable self-adhesive wine bottle labels adhered in consecutive fashion along a concertina folded backing web where the web is folded with perforations extending along each fold line so that folding is compact between successive webs and there are at least two stacks of such concertina folded backing web, which are connected so that a first stack is connected to a second stack by having a tail of the first stack connected to a top of the second stack.

10. A method of machine labelling of beverage containers with self-adhesive labels by using a plurality of units of label feedstock, each unit of feedstock having machine releasable self-adhesive beverage container labels adhered to a concertina folded backing web, wherein the backing web of a unit of feedstock is joined to the backing web of another unit of feedstock.
